(19) United States
(12) Patent Application Publication
(10) Pub. No.: US 2018/0257270 A1
(43) Pub. Date: Sep. 13, 2018

(54) MOLD, METHOD FOR FORMING MOLD, AND CASTING METHOD

(71) Applicant: Yuuya Endoh, Kanagawa (JP)

(72) Inventor: Yuuya Endoh, Kanagawa (JP)

(21) Appl. No.: 15/836,995

(22) Filed: Dec. 11, 2017

(30) Foreign Application Priority Data
Mar. 13, 2017 (JP) 2017-047379

(51) Int. Cl. B29C 39/38; C08J 3/075; C08J 3/24; B29C 39/00; B29C 33/38

(52) U.S. Cl. CPC B29C 39/38; C08J 3/075; C08J 3/24; B29L 2031/757; B29C 33/38; C08J 2371/02; C08J 2405/04; B29C 39/003

(57) ABSTRACT

A mold includes a hydrogel material. The hydrogel material includes a hydrogel and a cross-linked structure. The hydrogel contains a temperature-responsive hydrogel-forming polymer A having a sol-gel transition temperature. The temperature-responsive hydrogel-forming polymer A is solated at a temperature lower than the sol-gel transition temperature and is gelated at a temperature higher than the sol-gel transition temperature. In the cross-linked structure, a cross-linking water-soluble polymer B to reinforce the hydrogel is cross-linked.

### CROSS-REFERENCE TO RELATED APPLICATIONS

This patent application is based on and claims priority pursuant to 35 U.S.C. § 119(a) to Japanese Patent Application No. 2017-047379, filed on Mar. 13, 2017, in the Japan Patent Office, the entire disclosure of which is hereby incorporated by reference herein.

### BACKGROUND

### Technical Field

Aspects of the present disclosure relate to a mold, a method for forming a mold, and a casting method.

### Related Art

There are two problems when forming a three-dimensional structure of a brittle material such as hydrogel or living tissue with a conventional metal or a mold made of plastic.

The first problem is a low on-demand nature. In order to form a mold, first, there is a need for a process of machining a metal or plastic material by cutting or the like. Further, when a shape of gel to be molded changes, it is necessary to newly manufacture the mold by cutting.

The second problem is an application of load due to mold release to a molded article obtained by molding a gel with a mold. When detaching the molded gel from the mold, friction may occur between an inner wall of the mold and the molded article. Thus, there is a possibility of destruction of the molded article. In particular, when casting a low-strength gel or a tissue containing cells, there is a problem that the shape of the molded article cannot be retained by the load of mold release, and a mechanical damage is applied to the cells.

As a means for forming a structure on demand, there is a 3D printer of the type called fused deposition modeling (FDM), and a water-soluble material such as polyvinyl alcohol is provided as a support material. If only the support material is shaped to form a mold, in order to remove the support material, after the support material is immersed in hot water, ultrasonic cleaning, scraping with a brush or the like is performed. Thus, the mechanical load on the casting inside the support material is large.

A temperature-responsive sol-gel transition material that undergoes a sol-gel transition reversibly due to temperature change is known as a material that can be removed without a mechanical load and can form a structure. For example, the temperature-responsive sol-gel transition materials are laminated to attempt shaping of the three-dimensional shape.

### SUMMARY

In an aspect of the present disclosure, there is provided a mold including a hydrogel material. The hydrogel material includes a hydrogel and a cross-linked structure. The hydrogel contains a temperature-responsive hydrogel-forming polymer A having a sol-gel transition temperature. The temperature-responsive hydrogel-forming polymer A is solated at a temperature lower than the sol-gel transition temperature and is gelated at a temperature higher than the sol-gel transition temperature. In the cross-linked structure, a cross-linking water-soluble polymer B to reinforce the hydrogel is cross-linked.

In another aspect of the present disclosure, there is provided a method for forming the mold. The method includes adding an aqueous solution containing a cross-linking agent to a molded article including a hydrogel containing the temperature-responsive hydrogel-forming polymer A and the cross-linking water-soluble polymer B from a surface of the molded article, to cross-link the cross-linking water-soluble polymer B.

In still another aspect of the present disclosure, there is provided a method for forming the mold. The method includes adding a cross-linking agent to an aqueous solution containing the temperature-responsive hydrogel-forming polymer A and the cross-linking water-soluble polymer B, to disperse the cross-linking agent in the aqueous solution; molding the aqueous solution with a mold; and heating the aqueous solution to form a hydrogel containing the temperature-responsive hydrogel-forming polymer A and cross-link the cross-linking water-soluble polymer B.

In still yet another aspect of the present disclosure, there is provided a casting method. The casting method includes casting a model material with the mold and cooling the model material to a temperature lower than the sol-gel transition temperature of the hydrogel after casting the model material, to break the mold and extract the model material.

In still further yet another aspect of the present disclosure, there is provided a casting method. The casting method includes casting a model material with the mold according to claim 1; cooling the model material to a temperature lower than the sol-gel transition temperature of the hydrogel after casting the model material; and de-cross-linking the cross-linked structure formed by cross-linking of the cross-linking water-soluble polymer B, using a de-cross-linking agent, to break down the mold and extract the model material.

### BRIEF DESCRIPTION OF THE SEVERAL VIEWS OF THE DRAWINGS

The aforementioned and other aspects, features, and advantages of the present disclosure would be better understood by reference to the following detailed description when considered in connection with the accompanying drawings, wherein:

FIG. 1 is a diagram illustrating a method for laminating and shaping a mold according to an embodiment of the present disclosure;

FIG. 2 is a diagram illustrating an internal structure of a non-cross-linked mold gel;

FIG. 3 is a diagram illustrating the internal structure of a cross-linked mold gel;

FIG. 4 is a diagram illustrating a mold according to an embodiment of the present disclosure;

FIG. 5 is a diagram illustrating a state in which an uncured model material of a flowing state is injected into the mold according to an embodiment of the present disclosure;

FIG. 6 is a diagram illustrating a state in which the mold according to an embodiment of the present disclosure is collapsed; and

FIG. 7 is a diagram illustrating a state in which a sol is eluted from the mold of a collapsed state.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

There is known a method capable of solating a gelated product by cooling a three-dimensional modeled article to perform outflow and removal of the solated product.

However, in the case of such a method, although the temperature-responsive sol-gel transition material has shape retaining ability, strength is weak to the extent that the material is extruded from a syringe tip, and there is a disadvantage that the shape is collapsed when coming into contact with a model material to be casted and does not return. Thus, the temperature-responsive sol-gel transition material could not be used as a mold.

Despite that the solation and removal is useful as a mold, conventionally, the temperature-responsive sol-gel transition material has not been used as a mold owing to the problem of strength.

The present disclosure solves the above disadvantage.

The present disclosure relates to the mold described in the following (1), but includes the following (2) to (8) as embodiments of the disclosures. Thus, these embodiments will also be described together.

(1) A mold made of a hydrogel material,

in which the hydrogel material includes:

hydrogel containing a temperature-responsive hydrogel-forming polymer A having a sol-gel transition temperature which is solated at a temperature lower than a sol-gel transition temperature and is gelated at a temperature higher than the sol-gel transition temperature; and

a cross-linked structure in which a cross-linking water-soluble polymer B that reinforces the hydrogel is cross-linked.

(2) The mold according to (1), in which the hydrogel is substantially water-insoluble at a temperature equal to or higher than the sol-gel transition temperature.

According to the present embodiment, since the hydrogel is substantially water-insoluble at a sol-gel transition temperature or higher, even if a cross-linking agent in the form of an aqueous solution is added after molding the hydrogel, a mold can be produced without destroying the shape.

(3) The mold according to (1) or (2), in which the sol-gel transition temperature of the hydrogel is 0° C. to 40° C.

According to this embodiment, since the sol-gel transition temperature of the hydrogel is 0° C. to 40° C., it is possible to form and release the mold in the temperature range around room temperature.

(4) A method for forming the mold according to any one of (1) to (3), the method including:

adding an aqueous solution containing a cross-linking agent from a surface to a molded article including a hydrogel containing the temperature-responsive hydrogel-forming polymer A and the cross-linking water-soluble polymer B to cross-link the cross-linking water-soluble polymer B.

According to the present embodiment, in order to prepare a mold by cross-linking the cross-linking polymer B after molding the hydrogel, a mold can be formed after shaping a hydrogel in an arbitrary shape using a dispenser.

(5) A method for forming the mold according to any one of (1) to (3), the method including:

adding a cross-linking agent to an aqueous solution containing the temperature-responsive hydrogel-forming polymer A and the cross-linking water-soluble polymer B, dispersing the cross-linking agent, molding the mixture with a mold, and heating the aqueous solution, thereby forming a hydrogel containing the temperature-responsive hydrogel-forming polymer A, and cross-linking the cross-linking water-soluble polymer B.

According to this embodiment, since a hydrogel containing the cross-linking agent is used, it is possible to prepare a mold of a temperature-responsive sol-gel transition material, merely by pouring the cross-linking agent into another mold and raising the temperature.

(6) A casting method including:

casting a model material, using the mold according to any one of (1) to (3) and cooling the model material to a temperature less than the sol-gel transition temperature of the hydrogel after casting, thereby breaking the mold and extracting the model material.

According to the present embodiment, since the mold is broken by cooling the model material to the temperature less than the sol-gel transition temperature, it is possible to extract the cast model material without a mechanical load.

(7) A casting method including:

casting a model material, using the mold according to any one of (1) to (3);

cooling the model material to a temperature less than the sol-gel transition temperature of the hydrogel after casting; and

de-cross-linking the cross-linked structure formed by cross-linking of the cross-linking water-soluble polymer B, using a de-cross-linking agent, to break down the mold and extract the model material.

According to the present embodiment, since the model material can be extracted by solating the mold, it is possible to extract the cast model material without any mechanical load.

(8) The casting method according to (7), in which the cross-linking water-soluble polymer B is sodium alginate, the cross-linked structure is a cross-linked structure of calcium alginate, and the cross-linking agent is a chelating agent.

In the mold according to the embodiment of the present disclosure, since the hydrogel is reinforced by the cross-linked structure in which the cross-linking water-soluble polymer is cross-linked, it is possible to solve insufficient strength of the temperature-responsive sol-gel transition material. Further, since the mold of the present disclosure is a mold made of a temperature-responsive sol-gel transition material, it is possible to collapse and remove the mold, without accompanying a mechanical load by cooling the mold at the temperature less than the sol-gel transition temperature.

### [Temperature-Responsive Hydrogel-Forming Polymer a Having Sol-Gel Transition Temperature]

First, a temperature-responsive hydrogel-forming polymer A which is a temperature-responsive sol-gel transition material will be described.

In the temperature-responsive hydrogel-forming polymer A of the present disclosure, a hydrogel-forming polymer used in the present disclosure, in which its aqueous solution is a temperature-responsive sol-gel transition material, is not limited in particular, as long as the hydrogel-forming polymer has a sol-gel transition temperature at which the aqueous solution is solated at a temperature lower than the sol-gel transition temperature and is gelated at a temperature higher than the sol-gel transition temperature.

As an example of the hydrogel-forming polymer having the sol-gel transition temperature at which the aqueous solution is solated at a temperature lower than the sol-gel transition temperature and gelated at a temperature higher than the sol-gel transition temperature, there is mentioned methyl cellulose, 8-arms PEG-block-PLLA-cholesterol conjugate, or Poloxamer 407 sold commercially under the name of Poly [(Glc-Asp)-r-DL-LA]-g-PEG, Pluronic (registered trademark) F127 or Kolliphor (registered trademark) P407. However, the present disclosure is not limited to these hydrogel-forming polymers. Polroxamer 407 (hereinafter referred to as poloxamer) is desirable from the viewpoint that the aqueous solution can be subjected to sol-gel transition in the vicinity of the room temperature and availability is easy.

It is preferable that the sol-gel transition temperature of the hydrogel containing the hydrogel-forming polymer A is 0° C. to 40° C. The sol-gel transition temperature of the hydrogel can be adjusted by the concentration of the hydrogel-forming polymer A and additives.

When a poloxamer aqueous solution is used as a polymer solution having a sol-gel transition temperature, the sol-gel transition temperature can be adjusted by changing the concentration of the poloxamer. For example, the sol-gel transition temperature is about 20° C. in the case of the concentration of 20% by mass, and is about 30° C. to about 40° C. in the concentration of 15% by mass.

Further, when sodium chloride is added to the poloxamer aqueous solution having a concentration of 25% by mass, the sol-gel transition temperature can be adjusted from about 5° C. to about 10° C.

By changing the concentration of the poloxamer and additives, it is possible to select the sol-gel transition temperature lower than the casting temperature of the material to be molded inside the mold.

Further, a combination of methyl cellulose and sorbitol used for food additives is also desirable because the sol-gel transition temperature of the hydrogel is set to 40° C. or less and the availability is good.

### [Cross-Linking Water-Soluble Polymer B]

A cross-linking water-soluble polymer B added to the aqueous solution of the temperature-responsive hydrogel-forming polymer will be described.

The cross-linking water-soluble polymer B is added to the aqueous solution of the temperature-responsive hydrogel-forming polymer, and used to reinforce the entire mold by a cross-linked structure.

The cross-linking water-soluble polymer to be used is not limited in particular as long as it has a property of cross-linking by adding the cross-linking agent.

In order to stretch the cross-linked structure over the entire mold, the content of the cross-linking water-soluble polymer B in the aqueous solution forming the mold is desirably set to at least 0.3% by mass or more.

Examples of good availability of the cross-linking water-soluble polymer include sodium alginate having a carboxyl group as a functional group in the molecule or polyvinyl alcohol having a hydroxyl group. However, both the functional group and the water-soluble polymer are not limited in particular.

In the mold of the present disclosure, the feature of having the cross-linked structure formed by cross-linking the cross-linking water-soluble polymer B to reinforce the hydrogel can be checked by cloudiness of gel and an increase in storage elastic modulus.

In the mold of the present disclosure, the insufficient strength can be solved by the cross-linked structure. Specifically, the storage elastic modulus can be set to 25000 [Pa] or more. Agar can also be actually casted and transferred.

### [Cross-Linking Agent]

The cross-linking agent for cross-linking the cross-linking water-soluble polymer B will be described.

Examples of the cross-linking agent include salts having polyvalent metal ions such as calcium ions, iron (III) ions, and magnesium ions, borax, and the like. However, as long as a combination is provided by being mixed with the cross-linking water-soluble polymer B and cross-linked, there is no particular limitation. Further, in the mold obtained by cross-linking, it is desirable that the hydrogel be substantially water-insoluble at a temperature equal to or higher than the sol-gel transition temperature.

Since the hydrogel is substantially water-insoluble at a temperature equal to or higher than the sol-gel transition temperature, it is possible to prepare a model material which is casted by curing, using a model material in the form of an aqueous solution. For example, an agar gel can be prepared by pouring the aqueous solution of agar into the mold.

Since it is possible to prepare a model material casted by curing using a model material in the form of an aqueous solution, it is possible to check that the hydrogel is substantially water-insoluble at a temperature equal to or higher than the sol-gel transition temperature.

### [Method for Preparing Hydrogel Material]

The hydrogel material includes a cross-linked structure in which hydrogel having a sol-gel transition temperature solated at a temperature lower than the sol-gel transition temperature and gelated at a temperature higher than the sol-gel transition temperature and containing a temperature-responsive hydrogel-forming polymer A, and a cross-linking water-soluble polymer B that reinforces the hydrogel are cross-linked.

A method for preparing a hydrogel material before molding into a mold shape will be described.

The method for preparing the hydrogel material includes the following processes:
a process of adding the temperature-responsive hydrogel-forming polymer A and the cross-linking water-soluble polymer B to water and stirring and mixing to prepare an aqueous solution;
a process of shaping the aqueous solution into a mold shape by a shaping method to be described later; and
a process of cross-linking and reinforcing the cross-linking water-soluble polymer B by a cross-linking method to be described later.

The method for preparing the hydrogel material includes a process of adding the cross-linking agent in addition to the aforementioned processes, but the process of adding the cross-linking agent may be performed before or after the process of shaping into the shape of the mold. However, in order to reinforce the cross-linking water-soluble polymer B by stretching the cross-linked structure over the entire mold, it is preferable to mix and disperse the cross-linking water-soluble polymer B in an aqueous solution before shaping into the mold shape.

Hereinafter, a mixed aqueous solution of the temperature-responsive hydrogel-forming polymer A and the cross-linking water-soluble polymer B is referred to as “non-cross-linked aqueous solution for mold”, and hydrogel obtained by heating the “non-cross-linked aqueous solution for mold” to the sol-gel transition temperature or higher is referred to as “non-cross-linked mold gel”.

### [Method for Shaping Three-Dimensional Model of Gel]

A method of shaping a three-dimensional model of gel will be described.

The method for molding the non-cross-linked mold gel into the form of a mold includes a method for causing the non-cross-linked aqueous solution for mold less than the sol-gel transition temperature to flow into another mold, heating the non-cross-linked aqueous solution for mold to a temperature equal to or higher than the sol-gel transition temperature, and gelling the non-cross-linked aqueous solution for mold to mold a molded article, a method for laminating and shaping the heated non-cross-linked mold gel, and the like. However, the method for molding the hydrogel is not limited in particular in the present disclosure.

The non-cross-linked aqueous solution for mold is caused to flow into a molding mold made of a hard material such as metal or plastic, heated to a temperature equal to or higher than the sol-gel transition temperature, and then, the mold may be detached to extract the non-cross-linked molded article.

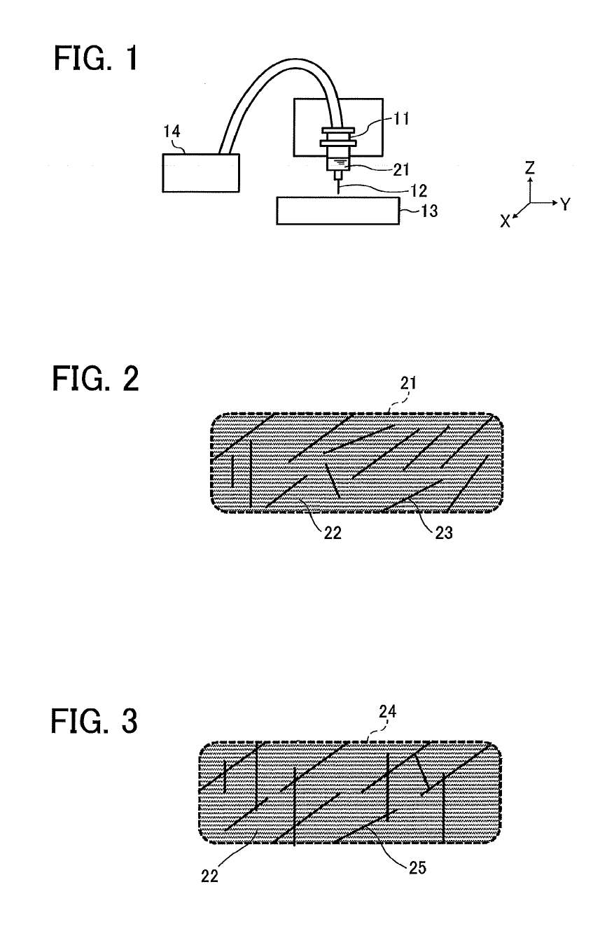

From the viewpoint of on-demand property, a laminate shaping method using a pneumatic dispenser illustrated in FIG. 1 may be used. The laminate shaping method will be described below.

### <Laminate Shaping Method>

The laminate shaping method will be described.

First, a syringe 11 into which a non-cross-linked mold gel 21 is injected is prepared.

(Process 1) An upper part of the syringe 11 is pressurized with compressed air, using a pneumatic dispenser 14, and the non-cross-linked mold gel 21 is discharged from the tip of a nozzle 12 below the syringe 11.

(Process 2) The syringe 11 and a base material on a driving stage 13 are relatively moved in a horizontal direction, using the driving stage 13.

(Process 3) A gel layer in the shape of the relative movement trajectory is formed on the base material.

(Process 4) While moving the driving stage 13, the non-cross-linked mold gel 21 is further discharged onto the formed gel layer to laminate the gel layers. A layer including a portion with no gel is formed.

By repeating Process 1 to Process 4 under an atmosphere or higher than the sol-gel transition temperature, the operation of laminating the gel layers of the polymer solution is repeated to obtain the shaped article (molded article) of the mold shape by the non-cross-linked mold gel having the same shape as the trajectory of the driving stage.

As a method for keeping the non-cross-linked mold gel at the sol-gel transition temperature or higher, a heating mechanism such as heating the stage and the syringe with a Peltier element, and shaping under a heating environment inside a thermostatic chamber is used. However, when the room temperature is higher than the sol-gel transition temperature, no heating mechanism is required.

A mold of the non-cross-linked mold gel may be formed by the aforementioned methods. However, in the present disclosure, the method for molding the non-cross-linked mold gel is not limited in particular.

### (Method for Cross-Linking of Cross-Linking Water-Soluble Polymer)

A method for cross-linking the cross-linking water-soluble polymer will be described.

In order to crosslink the cross-linking water-soluble polymer, a cross-linking agent is added. The cross-linking agent may be added to the non-cross-linked aqueous solution for the mold before molding or may be added after molding the non-cross-linked mold gel into the mold shape.

As illustrated in FIG. 2, in the non-cross-linked mold gel 21, a cross-linking water-soluble polymer B 23 is dispersed between hydrogels 22 containing the temperature-responsive hydrogel-forming polymer A.

Depending on the combination of the cross-linking water-soluble polymer and the cross-linking agent, such as sodium alginate and calcium chloride used in the method for manufacturing artificial salmon, in some cases, the cross-linking reaction may proceed in a short period of time of several seconds to one minute. In the case of a combination in which the cross-linking reaction proceeds in a short period of time, it is desirable that the process of adding the cross-linking agent is performed after molding the non-cross-linked mold gel into a mold shape. In the case of adding the cross-linking agent after molding the non-cross-linked mold gel into a mold shape, it is desirable that the form of the cross-linking agent be an aqueous solution. The molecules of the cross-linking agent contained in the aqueous solution containing the cross-linking agent permeate into the mold gel, and the cross-linking reaction between the cross-linking polymer and the cross-linking agent molecules occurs inside the mold gel. As a result, the entire inside of the mold is reinforced with the cross-linked structure of the cross-linking polymer.

Examples of a method for adding the aqueous solution of the cross-linking agent include a method for dropping the aqueous solution of the cross-linking agent, a method for applying the aqueous solution of the cross-linking agent to the mold gel, and a method for charging the mold gel into a water tank of the aqueous solution of the cross-linking agent, but the method for addition is not limited to the aforementioned methods.

Further, the process of adding the cross-linking agent may be performed in a process of adding the cross-linking agent to the non-cross-linked aqueous solution for the mold. Depending on the combination of the cross-linking water-soluble polymer and the cross-linking agent, in some cases, the cross-linking reaction may proceed for several tens of minutes or more, for example, as in a combination of polyvinyl alcohol and borax in an aqueous solution. In this case, after the cross-linking agent is added to the non-cross-linked aqueous solution for mold, the aqueous solution is rapidly stirred and caused to flow into another mold, and the aqueous solution is kept at the sol-gel transition temperature or higher to mold a non-cross-linked mold gel. Subsequently, the hydrogel constituting the mold is gradually reinforced with a cross-linked structure by the cross-linking reaction of the cross-linking water-soluble polymer. By the aforementioned method, a mold including a gel having a sol-gel transition temperature in which the whole is reinforced by cross-linking is obtained.

In the case of adding the cross-linking agent to the non-cross-linked aqueous solution for mold, since it is possible to stir the aqueous solution, even if the form of the cross-linking agent is an aqueous solution, powdery or granular, the entire mold can be cross-linked. Therefore, the form of the cross-linking agent is not limited in particular.

By the aforementioned method, the mold with the gel having the sol-gel transition temperature in which the whole is reinforced by cross-linking is obtained.

As illustrated in FIG. 3, the interior structure of a cross-linked mold gel 24 forming the mold of the present disclosure is a structure in which a cross-linked structure 25 of the cross-linking water-soluble molecular is stretched between the hydrogels 22 containing a temperature-responsive hydrogel-forming polymer.

### (Casting Method of Model Material)

A method for casting a model material using the mold reinforced with the cross-linking produced as described above will be described.

Examples of a model material to be casted using the mold includes, but is not limited to, a hydrogel, a biomaterial, and a silicon mold release agent, which are materials different from the mold material. The model material is not limited in particular as long as it is a material that is cured in a temperature range equal to or higher than the sol-gel transition temperature of the mold gel.

The method for casting the model material includes the following processes.

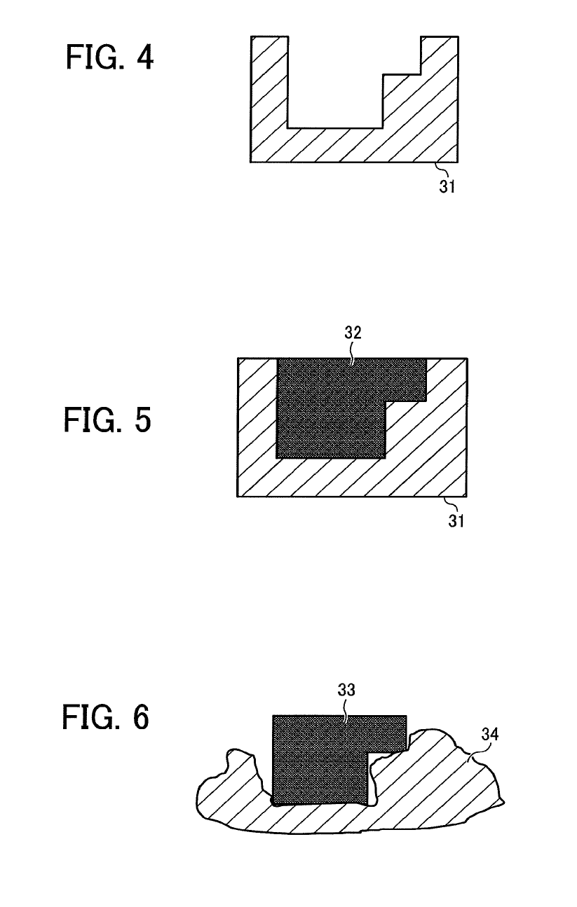

(Process 1) a process of keeping the mold 31 at a temperature equal to or higher than the sol-gel transition temperature of the mold material (see FIG. 4).

(Process 2) a process of injecting a model material 32 of an uncured flowing state into the opening portion of a mold 31 (see FIG. 5).

(Process 3) a process of curing the model material 32 of the injected flowing state to obtain a model material 33.

A model material is casted by performing Process 1 through Process 3 mentioned above.

As a method for keeping the temperature of the mold at a temperature equal to or higher than the sol-gel transition temperature, there is unrestricted means such as means for installing the mold on a hot plate or means for setting the mold under a heating environment in a thermostatic chamber. However, when the sol-gel transition temperature is room temperature or lower, it is not necessary to perform a special heat treatment.

Examples of the method for curing the model material may include heat dissipation, two-liquid mixing, UV irradiation, or the like depending on the type of the model material, but the method is not limited in particular. An agarose gel can be adopted as a model material that is cured by heat dissipation. Further, as a model material that is cured by two liquid mixing, a silicon mold release agent can be adopted. As a model material that is cured by UV irradiation, a UV resin can be adopted. However, the model material and the curing method are not limited in particular.

### (Method for Releasing Model Material)

A method for extracting the casted model material from the mold will be described.

The mold 31 of the present disclosure is released by keeping the mold 31 at a temperature less than the sol-gel transition temperature of the mold gel.

The mold 31 of the present disclosure holds the mold shape, by each of the hydrogel containing a temperature-responsive hydrogel-forming polymer and the cross-linked structure of the cross-linking water-soluble polymer. By keeping the mold at a temperature less than the sol-gel transition temperature of the hydrogel, the hydrogel containing the temperature-responsive hydrogel-forming polymer is solated, and its ability to retain the mold shape is lost.

As a result, the mold 31 turns into a shape 34 squashed by gravity, while holding the interface with the outside world, and can be released from the model material 33 casted without friction (see FIG. 6).

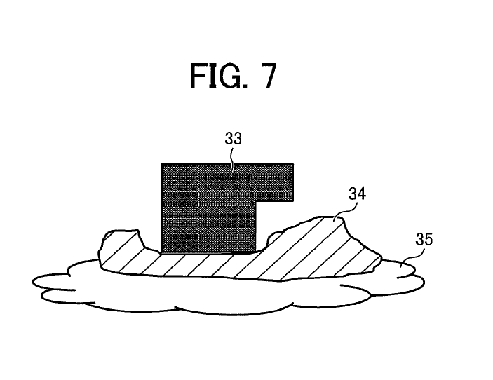

Further, as a result of intensive examination, it was found that, when keeping the mold at a temperature less than the sol-gel transition temperature for a long time of one day or longer, a hydrogel containing a temperature-responsive hydrogel-forming polymer inside the mold was solated, a sol 35 was eluted from the mold, and the sol 35 was further easily released by causing a phenomenon of contraction of the mold (see FIG. 7).

The mold of the present disclosure is obtained by holding a mold shape with the hydrogel containing the temperature-responsive hydrogel-forming polymer, and subsequently, by reinforcing the mold with a cross-linking water-soluble polymer. Therefore, the cross-linking method of the present disclosure is characterized by a low degree of freedom of movement of the cross-linking water-soluble polymer, and as compared to the case of molding a gel of only a cross-linking water-soluble polymer having the property of forming a hydrogel, a cross-linked structure with weaker shape retention ability is formed.

With this feature, when the shape retention ability of the hydrogel containing the temperature-responsive hydrogel-forming polymer disappears by keeping the mold at the temperature less than the sol-gel transition temperature, the entire mold loses shape retention ability, and the mold can be released by being crushed.

Further, after casting, the mold is cooled up to the temperature less than the sol-gel transition temperature of the hydrogel, and the cross-linked structure, in which the cross-linking water-soluble polymer B in the hydrogel is cross-linked, is de-cross-linked, using a de-cross-linking agent, to collapse the mold and extract the model material.

In the case where the cross-linking water-soluble polymer B is a metal salt of alginic acid, the mold is cooled and crushed, and a chelating agent may be added to de-crosslink the cross-linked structure of the cross-linking water-soluble polymer, thereby solating and removing the entire mold. When the cross-linking water-soluble polymer is sodium alginate and the cross-linking agent is calcium chloride, the cross-linked structure of the formed calcium alginate is deprived of calcium ions by the chelating agent and de-cross-linked to form a sol. Therefore, when the mold is cooled and a chelating agent is added, the entire mold is solated, and the model material can be more easily extracted.

As the chelating agent, an aqueous solution of EDTA or sodium citrate can be adopted. However, as long as it has a property of depriving metal ions from the cross-linked structure of the cross-linking water-soluble polymer, there is no particular limitation.

### (Method for Evaluating Mold Strength)

A method for evaluating the strength of the cross-linked mold will be described.

The strength was evaluated by the storage elastic modulus of the gel material.

The method for evaluating the storage elastic modulus will be described below.

A parallel plate sensor having a diameter of 25 mm was mounted on Rheometer (Anton Paar GmbH, MCR301) to measure the storage elastic modulus under the conditions of a gap of 1 mm from a measuring target, frequency of 1 Hz, and strain of 0.5%.

### Example

Hereinafter, the present disclosure will be described in more detail on the basis of examples, but the technical scope of the present disclosure is not limited to the following examples at all. Symbol “%” indicating the component ratio in Table 1-1 is “% by mass”.

### Example 1

Sodium alginate (Kimica Corp., Kimica Algin IL-2) as a cross-linking water-soluble polymer was added to pure water kept at 10° C. or less using a beaker of which the periphery was cooled with ice, using Poloxamer 407 (BASF Japan Ltd., Kolliphor (registered trademark) P407) as the temperature-responsive hydrogel-forming polymer, and dissolved by stirring to prepare [aqueous solution A]. The concentration of Poloxamer 407 was 18% by mass and the concentration of sodium alginate was 0.5% by mass.

The storage elastic modulus of transparent gel obtained by heating [aqueous solution A] of a sol state at room temperature of 15° C. to 37° C. was evaluated by the evaluation method, and the result was 11000 [Pa].

Further, after heating [aqueous solution A] to 37° C. to gelate, aqueous solution of 20% by mass of calcium chloride was dripped and left for 2 minutes. As a result, a cloudy gel was obtained in which the whole was cross-linked with calcium alginate. The aqueous solution of calcium chloride remaining around the cloudy gel was removed by suction with a dropper. The result of measuring the storage elastic modulus of the obtained cross-linked gel at 37° C. by the aforementioned evaluation method was 30000 [Pa]. The strength increased about 3 times compared to a state before cross-linking treatment.

Also, the storage elastic modulus measured by cooling the obtained cross-linked gel to 15° C. was 13000 [Pa], and a result of substantially the same intensity as before performing the cross-linking treatment was obtained.

After 3 g of the cross-linked gel obtained was cooled to 15° C., 10 g of the aqueous solution of 3% by mass of citric acid trisodium dihydrate was dripped and left for 1 hour. It was checked that all the gels were solated and eluted as a result of the process.

Further, when the obtained cross-linked gel was cut with a cutter, it was possible to be checked that the whole inside was cloudy.

### Comparative Example 1

Poloxamer 407 was added to pure water kept at 10° C. or less using a beaker of which the periphery was cooled with ice, and dissolved by stirring to prepare [aqueous solution B].

The concentration of Poloxamer 407 of [aqueous solution B] was 18% by mass.

The result of measuring the storage elastic modulus of the gel obtained by heating [aqueous solution B] to 37° C. by the above evaluation method was 11000 [Pa].

The aqueous solution of 20% by mass of calcium chloride was dripped to the gel obtained by heating [aqueous solution B] to 37° C. and left for 2 minutes, and subsequently, the aqueous solution of calcium chloride around the gel was removed by suction with a dropper.

The result of measuring the storage elastic modulus of the obtained transparent gel at 37° C. by the above evaluation method was 11500 [Pa]. The measured result was almost the same as before dripping calcium chloride.

### Comparative Example 2

Poloxamer 407 and sodium alginate were added to pure water kept at 10° C. or lower using a beaker of which the periphery was cooled with ice, and dissolved by stirring. Further, powdery calcium chloride was charged and dissolved by stirring. By the aforementioned operation, a gel of calcium alginate was formed by a cross-linking reaction between sodium alginate and calcium chloride, and [aqueous solution C] of Poloxamer 407 in which the gel of calcium alginate was dispersed in a state of being finely broken by stirring was obtained.

The concentration of Poloxamer 407 of [aqueous solution C] was 18% by mass. In addition, the amount of sodium alginate added was 0.5% by mass and the amount of calcium chloride was 0.2% by mass with respect to the mass of [aqueous solution C].

The storage elastic modulus of the translucent white gel obtained by heating the aqueous solution C to 37° C. was measured by the above evaluation method, and the measured result was 12000 [Pa]. The measured result was almost the same as in Comparative example 1.

The obtained gel is in a state in which gels of individual broken calcium alginate individually float inside the hydrogel of Poloxamer 407. Therefore, the structure is different from the structure in which the hydrogel of Poloxamer 407 illustrated in Example 1 is reinforced with a cross-linked structure.

For comparison, an aqueous solution C′ not containing powdery calcium chloride and having a concentration of Poloxamer 407 of 18% by mass and a concentration of sodium alginate of 0.5% by mass was prepared.

The storage elastic modulus of a transparent gel obtained by heating [aqueous solution C′] in the sol state at room temperature of 15° C. to 37° C. was measured by the above evaluation method, and the measured result was 11000 [Pa].

### (Laminate Shaping Using Aqueous Solutions A to C)

Each of the aqueous solution A, the aqueous solution B, and the aqueous solution C were laminated and shaped, using a dispenser inside a thermostatic chamber kept at 37° C., and a box-shaped mold having an inner wall thickness of 3 mm, an outer circumference of 21 mm square in length and width, a height of 15 mm, an inner cavity of vertical and horizontal 15 mm square, and a depth of 13 mm was obtained.

For laminate shaping, an air pulse type dispenser (Musashi Engineering Inc. ML-5000 XII), and syringe nozzle (tip inner diameter of 0.4 mm) were used. Also, shaping was performed on a PET film on a belt-driving type XYZ stage. Gels of aqueous solution A, aqueous solution B, and aqueous solution C were discharged from the syringe along the trajectory of the movement of the XYZ stage to perform laminate shaping.

The aqueous solution of 20% by mass of calcium chloride was dripped to the gel mold of the aqueous solution A and the aqueous solution B, and the mixture was left for 2 minutes.

Agar (Wako Pure Chemical Industries, Ltd.) was dissolved in pure water at 90° C. at a concentration of 1.5% by mass, and an aqueous solution X cooled to 55° C. was obtained.

An aqueous solution X of 55° C. was injected to the mold of the cross-linking gel of the obtained aqueous solution A (hereinafter referred to as the mold of Example 1), the mold of the aqueous solution B (hereafter referred to as the mold of Comparative example 1), and the mold of the aqueous solution C (hereinafter referred to as the mold of Comparative example 2) up to the margin of the mold and left for 12 hours to cast an agar gel. Next, the installation temperature of the thermostatic chamber was lowered to 10° C. and left for 2 hours to soften the mold of Example 1, the mold of Comparative example 1, and the mold of Comparative example 2, and the agar gel casted from each mold was extracted. At this time, it was checked that the mold of Example 1 was separated into a clouded and crushed gel, and transparent solute eluted from the gel.

In the agar gel obtained from the mold of Example 1, the outer diameters of the lower part and the upper part were 21 mm in length and width and the height was 14 mm.

In the agar gel from the mold of Comparative example 1, the outer diameter of the lower part was 21 mm in length and width, the outer shape of the upper part was 25 mm in length and width, and the height was 11 mm.

In the agar gel obtained from the mold of Comparative example 2, the outer diameter of the lower part was 21 mm in length and width, the outer shape of the upper part was 23 mm in length and width, and the height was 12 mm.

Only the agar gel obtained from the mold of the cross-linked gel of the aqueous solution A was in the shape of a square pillar to which the shape of the internal cavity of the original mold was transferred. The agar gel obtained from the other mold had a tapered shape with one side swollen, and the shape of the inner cavity of the mold could not be transferred.

The results of the first example, the first comparative example, and Comparative example 2 revealed that the mold of the present disclosure can be used as a mold and can be released without a mechanical load.

### Example 2

Polyvinyl alcohol (Denka Company Limited, Denka Poval A-50) was added as a cross-linking water-soluble polymer to pure water kept at 10° C. or lower, using a beaker of which the periphery was cooled with ice, and was dispersed by stirring. The obtained aqueous solution was heated and stirred at 90° C. for 30 minutes, then cooled with ice to 10° C. or less and added with water. Subsequently, Poloxamer 407 and borax (Wako Pure Chemical Industries, Ltd.) as a cross-linking agent were added to the aqueous solution kept at 10° C. or less, and dissolved by stirring to obtain [aqueous solution D]. The concentration of Poloxamer 407 of [aqueous solution D] was 18% by mass, the concentration of polyvinyl alcohol was 3% by mass, and the concentration of borax was 3% by mass.

The obtained [aqueous solution D] was left to stand at 37° C. for 6 hours, the storage elastic modulus of the obtained gel was measured by the above evaluation method, and the measured result was 27000 [Pa].

For comparison, an aqueous solution D′ was prepared in which the concentration of Poloxamer 407 was 18% by mass and the concentration of polyvinyl alcohol was 3% by mass without adding borax. The storage elastic modulus of the gel obtained by leaving to stand the aqueous solution D′ at 37° C. for 6 hours was measured by the above evaluation method, and the measured result was 10500 [Pa].

A cylindrical silicon rubber tube B having an outer diameter of 12 mm and a height of 20 mm, which was manufactured by rolling a silicon rubber sheet having thickness of 1 mm, was installed on a PET film inside a thermostatic chamber of 37° C. in an erected posture. Further, a cylindrical silicon rubber tube A having an inner diameter of 20 mm and a height of 20 mm, which was manufactured by rolling a silicon rubber sheet having a thickness of 1 mm was installed in an erected posture so as to cover the silicon rubber tube B.

After preparing the aqueous solution D, the aqueous solution D was promptly caused to flow into the space between the silicon rubber tube A and the silicon rubber tube B inside the thermostatic chamber and left for 6 hours.

Subsequently, the silicon rubber tube A and the silicon rubber tube B were carefully pulled out to obtain a gel mold (hereinafter referred to as a mold of Example 2) of the cross-linked aqueous solution D.

The mold of Example 2 had a cylindrical shape with an inner diameter of 12 mm and a height of 15 mm.

An aqueous solution X of 55° C. was poured into the obtained cylindrical mold of Example 2 as in the first embodiment and left for 12 hours. Then, the internal temperature of the thermostatic chamber was lowered to 10° C. and left for 2 hours, and the agar gel was extracted from the softened mold.

The obtained agar gel had a cylindrical shape with an outer diameter of 12 mm and a height of 14 mm, and a shape obtained by transferring the shape inside the mold was obtained.

### Example 3

First, sorbitol acting to lower the sol-gel transition temperature was dissolved and stirred in pure water of a beaker under a warm bath of 70° C. Next, the beaker was ice-cooled to 10° C. or lower to dissolve and stir methylcellulose (Shin-Etsu Chemical Co., Ltd., MCE-400) as a temperature-responsive hydrogel-forming polymer and sodium alginate as a cross-linking water-soluble polymer (Kimica Corp., Kimica algin IL-2). The pure water of the volume reduced by vaporization was added to adjust the concentration, and an aqueous solution E containing methyl cellulose of 2% by mass, sodium alginate of 0.5% by mass, and sorbitol of 20% by mass was obtained.

The storage elastic modulus of the gel obtained by heating the aqueous solution E to 37° C. was measured by the above evaluation method, and the measured result was 3000 [Pa]. In addition, the aqueous solution of 20% by mass of calcium chloride was added to the gel of the aqueous solution E and cross-linked to obtain a gel. The storage elastic modulus of the cross-linked gel kept at 37° C. was measured, and the measured result was 28000 [Pa]. In addition, the cross-linked gel was cooled to 15° C. and the storage elastic modulus was measured. The measured result was 7000 [Pa].

The obtained aqueous solution E was laminated and shaped at 37° C. in the same manner as in Example 1 to obtain a box-shaped mold (hereinafter referred to as a mold of Example 3) having a thickness of an inner wall of 3 mm, an outer circumference of 21 mm square in length and width, a height of 15 mm, an inner cavity of 15 mm square in length and width, and a depth of 13 mm. An aqueous solution X of 55° C. was injected into the obtained mold of Example 3 as in Example 1 until reaching the edge of the mold, and left for 12 hours. Then, the internal temperature of the thermostatic chamber was lowered to 10° C. and left for 2 hours, and the agar gel was extracted from the softened mold. The obtained agar gel had an outer diameter of 21 mm in length and width and a height of 14 mm, and the shape of a quadrangular prism with the inner wall of the mold transferred was obtained.

Durability against the external force of the mold was tested.

The molds of Examples 1 to 3 and the molds of Comparative examples 1 and 2 were prepared again. The flat plate portions of tweezers made of stainless steel with the width of 5 mm were pressed against the respective molds from above, and the tweezers were sunk by 2 mm with respect to the mold. After that, the tweezers were gently removed. The results of the behavior of the mold after removal of the tweezers are summarized in Tables 1-1 and 1-2. A sample returned to its original shape was evaluated as good, and a sample remained in a recessed shape was evaluated as poor.

The molds of Examples 1 to 3 were returned to their original shapes, and the molds of Comparative examples 1 and 2 were remained in a recessed shape in a portion against which the tweezers were pressed. Also, from this result, it can be seen that the mold of the present disclosure is a mold which solved the disadvantage of insufficient strength due to the cross-linked structure.

Tables 1-1 and 1-2 illustrates the compositions and evaluation results of the aqueous solutions in which the molds of the examples and the comparative examples were formed.

Regarding the transferability of the agar gel, the case capable of performing the transfer was indicated by “Good”, and the case incapable of performing the transfer was indicated by “Bad”.

TABLE 1-1

| | | | | Sol-gel | | | | |
|---|---|---|---|---|---|---|---|---|
| | | Hydrogel- | | transition | Cross-linking | | | |
| | | forming | | temperature | water-soluble | | Cross-linking | |
| | | polymer A | | adjusting | polymer B | | agent | |
| | Type of | [% by mass] | | agent | [% by mass] | | [% by mass] | |
| | aqueous | Poloxamer | Methyl | [% by mass] | Sodium | Polyvinyl | Calcium | |
| | solution | 407 | cellulose | Sorbitol | alginate | alcohol | chloride | Borax |
| Example 1 | Aqueous | 18 | — | — | 0.5 | — | Dripping | — |
| | solution A | | | | | | of 20% | |
| | | | | | | | aqueous | |
| | | | | | | | solution | |
| Comparative | Aqueous | 18 | — | — | — | — | Dripping | — |
| example 1 | solution B | | | | | | of 20% | |
| | | | | | | | aqueous | |
| | | | | | | | solution | |
| Comparative | Aqueous | 18 | — | — | 0.5 | — | 0.2 | — |
| example 2 | solution C | | | | | | (powder) | |
| Example 2 | Aqueous | 18 | — | — | — | 3 | — | 3 |
| | solution D | | | | | | | |
| Example 3 | Aqueous | — | 2 | 20 | 0.5 | — | Dripping | — |
| | solution E | | | | | | of 20% | |
| | | | | | | | aqueous | |
| | | | | | | | solution | |

TABLE 1-2

| | | Storage elastic modulus [Pa] | | | |
|---|---|---|---|---|---|
| | | Before | | | |
| | Process in which | addition of | After addition | | |
| | cross-linking | cross-linking | of cross-linking | Durability | Transferability of |
| | proceeds | agent | agent | evaluation | agar gel |
| Example 1 | After gelling | 11000 | 30000 | Good | Good |
| Comparative | — | 11000 | 11500 | Bad | Bad |
| example 1 | | | | | |
| Comparative | At the time of | 11000 | 12000 | Bad | Bad |
| example 2 | preparation of | | | | |
| | aqueous solution | | | | |
| Example 2 | During mold | 10500 | 27000 | Good | Good |
| | shaping | | | | |
| Example 3 | After gelling | 3000 | 28000 | Good | Good |

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A mold comprising a hydrogel material,
the hydrogel material including:
a hydrogel containing a temperature-responsive hydrogel-forming polymer A having a sol-gel transition temperature, the temperature-responsive hydrogel-forming polymer A solated at a temperature lower than the sol-gel transition temperature and gelated at a temperature higher than the sol-gel transition temperature; and
a cross-linked structure in which a cross-linking water-soluble polymer B to reinforce the hydrogel is cross-linked.

2. The mold according to claim 1,
wherein the hydrogel is substantially water-insoluble at a temperature equal to or higher than the sol-gel transition temperature.

3. The mold according to claim 1,
wherein the sol-gel transition temperature of the hydrogel is in a range of from 0° C. through 40° C.

4. A method for forming the mold according to claim 1, the method comprising:
adding an aqueous solution containing a cross-linking agent to a molded article including a hydrogel containing the temperature-responsive hydrogel-forming polymer A and the cross-linking water-soluble polymer B from a surface of the molded article, to cross-link the cross-linking water-soluble polymer B.

5. A method for forming the mold according to claim 1, the method comprising:
adding a cross-linking agent to an aqueous solution containing the temperature-responsive hydrogel-forming polymer A and the cross-linking water-soluble polymer B, to disperse the cross-linking agent in the aqueous solution;
molding the aqueous solution with a mold; and
heating the aqueous solution to form a hydrogel containing the temperature-responsive hydrogel-forming polymer A and cross-link the cross-linking water-soluble polymer B.

6. A casting method comprising:
casting a model material with the mold according to claim 1; and
cooling the model material to a temperature lower than the sol-gel transition temperature of the hydrogel after casting the model material, to break the mold and extract the model material.

7. A casting method comprising:
casting a model material with the mold according to claim 1;
cooling the model material to a temperature lower than the sol-gel transition temperature of the hydrogel after casting the model material; and
de-cross-linking the cross-linked structure formed by cross-linking of the cross-linking water-soluble polymer B, using a de-cross-linking agent, to break down the mold and extract the model material.

8. The casting method according to claim 7,
wherein the cross-linking water-soluble polymer B is sodium alginate,
wherein the cross-linked structure is a cross-linked structure of calcium alginate, and
wherein the de-cross-linking agent is a chelating agent.
